(19) United States
(12) Patent Application Publication
(10) Pub. No.: US 2025/0048996 A1
(43) Pub. Date: Feb. 13, 2025

(54) Service Dog Pull

(71) Applicant: Madeleine Anne Naumoff, New Albany, OH (US)

(72) Inventor: Madeleine Anne Naumoff, New Albany, OH (US)

(21) Appl. No.: 18/366,153

(22) Filed: Aug. 7, 2023

(51) Int. Cl. A01K 15/02

(52) U.S. Cl. CPC A01K 15/025

(57) ABSTRACT

A service dog pull including a ball or other biting object attached to a rope, with the biting object containing a hollow, interior cavity and outer surface allowing for ropes to enter and exit the ball, and using a knot design to fasten the ball to the rope.

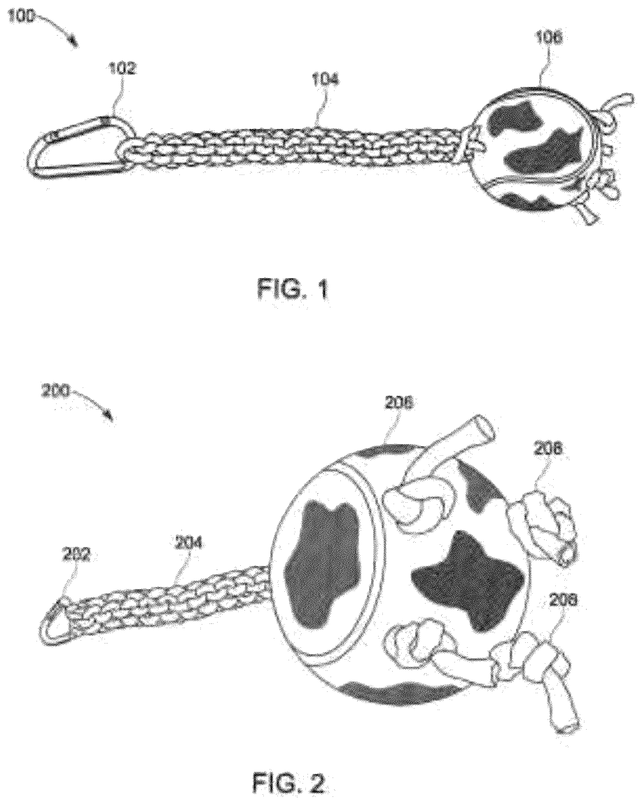

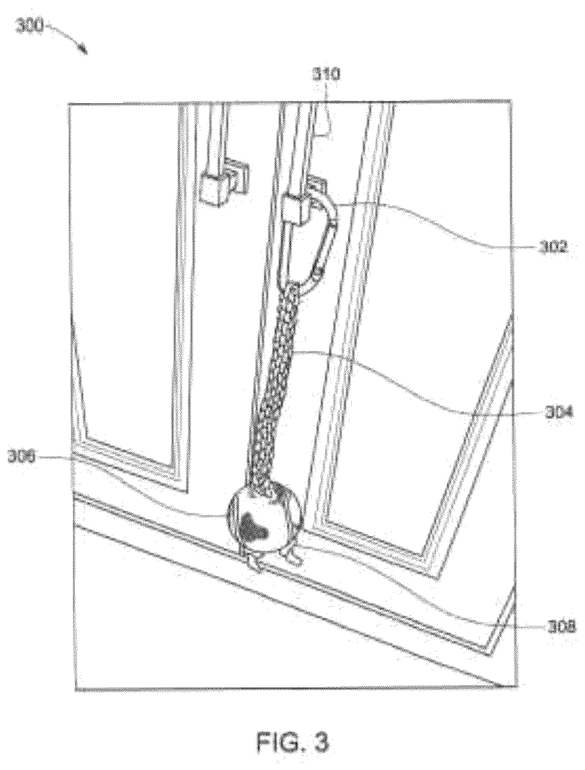

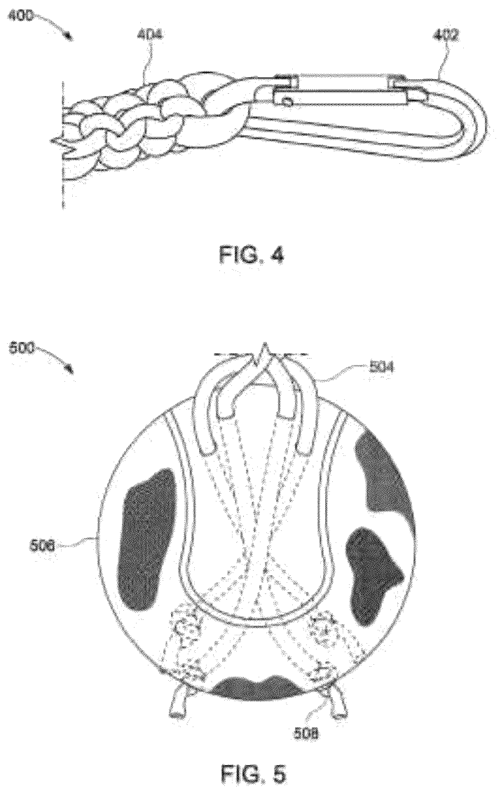

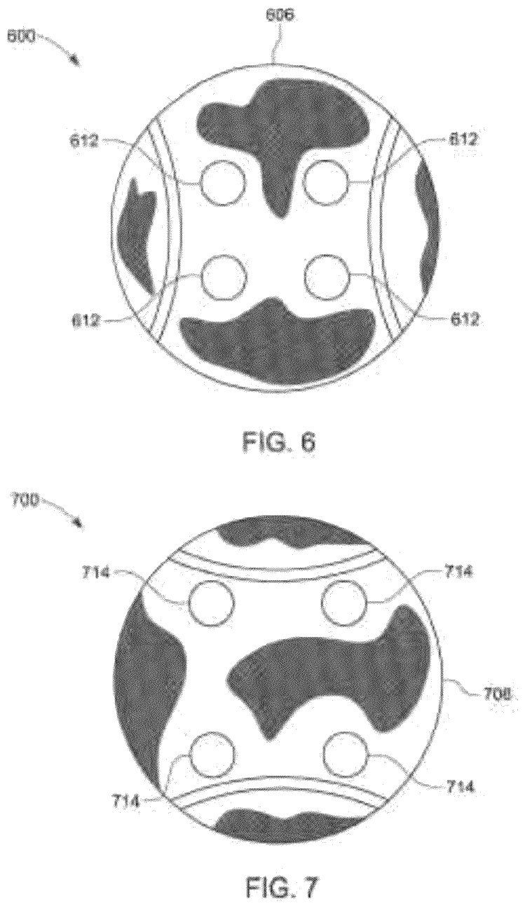

### FIELD OF INVENTION

The present invention relates generally to devices or tools utilized by service dogs to assist persons with disabilities and limitations impacting the activities of daily life. In particular, the present invention allows a service dog to grip a rope and ball device with its mouth and teeth to allow the service dog to use tension to open or otherwise move the item to which the device is attached.

### BACKGROUND OF THE INVENTION

Service dogs are used to help people with disabilities of all types as well as individuals with limited mobility. There are many different types of service dogs and different types of activities that they can perform. Also these service dogs can use a variety of devices or tools to allow them to better perform the tasks for which they are trained. One example is a service dog trained to assist individuals with limited or no eyesight. Another example is a service dog that can assist with the pulling of a wheelchair or the retrieval of items that drop to the floor or are otherwise unreachable to an individual due to physical limitations. Also there are service dogs that can assist individuals with limitations that are not physical in nature, such as post traumatic stress disorders. Many of these service dogs can expand what they can do to assist their owners through the use of various tools and devices depending upon the specific tasks to be accomplished.

Currently, service dogs have the option of using dog “toys” that are designed for play and enjoyment of the dog rather than actual service work. These toy devices do not provide the attributes necessary for the service dog to be able to effectively grip and control the dog pull in the manner necessary for their service to their individual. As a result, problems and limitations occur when service dogs are forced to utilize dog toys to perform their service duties.

First, the material used for the rope section of many dog toys does not provide a hygenic material that is preferred for continued use by a service animal. Without a cleanable material that is resistant to bacteria and dirt, the rope section of existing toys do not suit well for dog service work.

Second, the tension that a service dog requires to make the more delicate motions needed, as compared to use as a toy, are not available in current dog toys to fulfill service dog needs. The routing of the roping through the interior of the tennis ball is crucial in terms of the service dog's ability to control the pull of the device to which it is attached.

Third, a convenient and adaptable means is needed to attach the pull device to the object being pulled, taking into account the need to adjust to a variety of different handles and attachment items. This attachment is an important part of creating a working device adaptable to multiple circumstances.

In the field of service dog pulls there is not an adequate tool for the needs and requirements of service dogs and their owners who depend upon their work. The present invention is a result of research efforts concerning these problems and development efforts on products to overcome such problems.

### OBJECTS OF THE INVENTION

It is an object of the invention to provide an improved service dog pull that overcomes the problems and shortcomings of the dog toys currently available on the market.

Another object of this invention is to provide a service dog pull that has an internal rope threading structure within the tennis ball that provides the service dog superior control over the pull tension created.

Another object of this invention is to provide a service dog pull that utilizes a polypropylene rope that offers superior qualities for continued sanitary use and better ability for cleaning and maintenance.

A further object of the present invention is to provide a service dog pull which offers a reliable and secure means to attach the pull to the object to which it is pulling.

Another key object of the present invention is to provide a material, as presented by a standard tennis ball, to which the service dog can easily grip with its mouth and teeth to create the tension needed to pull objects as needed.

How these and other objects are accomplished will be explained in the following descriptions and the drawings.

### SUMMARY OF THE INVENTION

The present invention provides a service dog pull and a method of manufacture overcoming the problems described above. It provides service dogs and their owners a novel means by which the service dog can pull objects with superior strength and control allowing the service animal to accomplish greater and more difficult tasks as compared to use of other dog toy devices available.

In this novel service dog pull, the biting object is comprised of a standard tennis ball 106 which has a hollow interior cavity 506 and a felt-like outer surface material 206 typical of a tennis ball that has holes in it to allow the rope to be threaded into the cavity. The tennis ball can be of any manufacture and of any color. This biting object will be gripped by the service dog from the sides of the ball since the rope is thread through the top and bottom, which encourages the correct placement of the dog's mouth on the ball for best control of tension.

In one embodiment, the rope is made of a polypropylene material 404 which is 3.9 mm in diameter. This rope material is first looped through the clip 402 at the top of the service dog pull, and is square braided 304 to a length of 6 inches. The four ends of the rope then are inserted into the tennis ball holes which are at the top of the ball 606. The four holes are in a square position with diagonal holes being 2.5 cm apart. The four ropes enter the interior of the ball and cross diagonally and exit at the bottom four holes 700 which are also arranged in a square shape with diagonal holes being 4 cm apart. This crossing of the ropes within the ball, as well the varied distances between the holes on the top versus the bottom of the ball, create the enhanced level of control and tension that the service dog has using this invention.

1. In a service dog pull of the type including a biting object for a dog to grasp attached to a rope to be held by a fastening device, the improvement where:
the biting object has a hollow interior cavity and a outer surface allowing for four rope openings into the cavity and four openings exiting the cavity; and
the four ropes have first and second end portions, the first end portions extending into the cavity through the openings, and the second end portions exiting the cavity through the bottom openings, where secured by a complex of knots outside the cavity.

2. The service dog pull of claim 1 wherein the biting object is a tennis ball.

3. The service dog pull of claim 2 wherein the complex of knots is a complex knot formed by at least two single knots exiting the interior cavity.

4. The service dog pull of claim 2 wherein the rope is formed by at least four strands which are square braided.

5. The service dog dog pull of claim 2 wherein the four holes on top and bottom of the biting object are in a square position.

6. The service dog pull of claim 2 wherein the four ropes exiting the bottom of the biting object are tied with double simple knots to each other.

7. The service dog pull of claim 2 wherein the interior of the biting object allows for the four stands of rope to cross diagonally within the interior.
